(19) United States
(12) Patent Application Publication
(10) Pub. No.: US 2025/0055795 A1
(43) Pub. Date: Feb. 13, 2025

(54) CU-DU FLOW CONTROL OPTIMIZATIONS FOR LOSSY MIDHAUL IN O-RAN NETWORKS

(71) Applicant: Mavenir Systems, Inc., Richardson, TX (US)

(72) Inventors: Sayee Kompalli, Bangalore (IN); Mukesh Taneja, Bangalore (IN); Sunil Kaimalettu, Bengaluru (IN)

(73) Assignee: Mavenir Systems, Inc., Richardson, TX (US)

(21) Appl. No.: 18/794,552

(22) Filed: Aug. 5, 2024

(30) Foreign Application Priority Data
Aug. 10, 2023 (IN) 202321053752

(51) Int. Cl. H04L 47/11; H04L 47/2408

(52) U.S. Cl. CPC H04L 47/11; H04L 47/2408

(57) ABSTRACT

A method for optimizing Control Unit (CU)-Distributed Unit (DU) flow control to detect congestion over midhaul and take corrective action to reduce packet dropping in the midhaul includes: computing, by DU, desired data rate (DDR) for each data radio bearer (DRB); and sending, by the DU, the DDR every time when desired buffer size (DBS) is sent from DU to CU user plane (CU-UP), along with Downlink Data Delivery Status (DDDS). DU computes DDR for a DRB as follows: DDR=TBS(MCS″, prb″, rank)*(number of slots/subframe in 1 sec)*(beta)*(beta_drb), with TBS being the Transport block size computation, and MCS″=min {(current MCS+MCS_step), MCSmax}.

### CROSS-REFERENCE TO RELATED APPLICATIONS

The present application claims priority to Indian Provisional Patent Application No. 202321053752 filed on Aug. 10, 2023, the entirety of which is incorporated by reference herein.

### BACKGROUND OF THE INVENTION

### 1. Field of the Invention

The present disclosure is related to Open Radio Access Network (O-RAN) systems, and relates more particularly to optimizing CU-DU flow control for lossy midhaul in O-RAN networks.

### 2. Description of Related Art

In the following sections, overview of Next Generation Radio Access Network (NG-RAN) architecture and 5G New Radio (NR) stacks will be discussed. 5G NR (New Radio) user and control plane functions with monolithic gNB (gNodeB) are shown in FIGS. 1, 2 and 3. For the user plane (shown in FIG. 1, which is in accordance with 3GPP TS 38.300), PHY (physical), MAC (Medium Access Control), RLC (Radio Link Control), PDCP (Packet Data Convergence Protocol) and SDAP (Service Data Adaptation Protocol) sublayers originate in the UE 101 and are terminated in the gNB 102 on the network side.

In addition, as shown in FIG. 2 (which is accordance with 3GPP TS 23.501), which is a block diagram illustrating the user plane protocol stacks for a PDU session of 5G NR, the Protocol Data Unit (PDU) layer 9010 corresponds to the PDU carried between the user equipment (UE) 101 and the data network (DN) 9011 over the PDU session. As shown in FIG. 2, UE 101 is connected to the 5G access network (AN) 902, which AN 902 is in turn connected via the N3 interface to the Intermediate UPF (I-UPF) 903a portion of the UPF 903, which I-UPF 903a is in turn connected via the N9 interface to the PDU session anchor 903b portion of the UPF 903, and which PDU session anchor 903b is connected to the DN 9011. The PDU session can correspond to Internet Protocol version 4 (IPv4), IPv6, or both types of IP packets (IPv4v6). General Packet Radio Services (GPRS) Tunneling Protocol-User Plane (GTP-U) shown in FIG. 2 supports tunnelling user plane data over N3 and N9 interfaces and provides encapsulation of end user PDUs for N3 and N9 interfaces.

For the control plane (shown in FIG. 3, which is in accordance with 3GPP TS 38.300), RRC (Radio Resource Control), PDCP, RLC, MAC and PHY sublayers originate in the UE 101 and are terminated in the gNB 102 on the network side, and NAS (Non-Access Stratum) originate in the UE 101 and is terminated in the AMF (Access Mobility Function) 103 on the network side.

NG-Radio Access Network (NG-RAN) architecture from 3GPP TS 38.401 is shown in FIGS. 4-5. As shown in FIG. 4, the NG-RAN consists of a set of gNBs connected to the 5GC through the NG interface. As shown in FIG. 4, the NG-RAN 301 consists of a set of gNBs 302 connected to the 5GC 303 through the NG interface. Each gNB comprises gNB-CU 304 and one or more gNB-DU 305 (see FIG. 4). As shown in FIG. 5 (which illustrates separation of CU-CP (CU-Control Plane) and CU-UP (CU-User Plane)), E1 is the interface between gNB-CU-CP (CU-Control Plane) 304a and gNB-CU-UP (CU-User Plane) 304b, F1-C is the interface between gNB-CU-CP 304a and gNB-DU 305, and F1-U is the interface between gNB-CU-UP 304b and gNB-DU 305. As shown in FIG. 5, gNB 302 can consist of a gNB-CU-CP 304a, multiple gNB-CU-UPs (or gNB-CU-UP instances) 304b and multiple gNB-DUs (or gNB-DU instances) 305.

One gNB-DU 305 is connected to only one gNB-CU-CP 304a, and one gNB-CU-UP 304b is connected to only one gNB-CU-CP 304a.

In this section, an overview Layer 2 (L2) of 5G NR will be provided in connection with FIGS. 6-8. L2 of 5G NR is split into the following sublayers (in accordance with 3GPP TS 38.300):

1) Medium Access Control (MAC) 501 in FIGS. 6-8: Logical Channels (LCs) are SAPs (Service Access Points) between the MAC and RLC layers. This layer runs a MAC scheduler to schedule radio resources across different LCs (and their associated radio bearers). For the downlink direction, the MAC layer processes and sends RLC PDUs received on LCs to the Physical layer as Transport Blocks (TBs). For the uplink direction, it receives transport blocks (TBs) from the physical layer, processes these and sends to the RLC layer using the LCs.

2) Radio Link Control (RLC) 502 in FIGS. 6-8: The RLC sublayer presents RLC channels to the Packet Data Convergence Protocol (PDCP) sublayer. The RLC sublayer supports three transmission modes: RLC-Transparent Mode (RLC-TM), RLC-Unacknowledged Mode (RLC-UM) and RLC-Acknowledgement Mode (RLC-AM). RLC configuration is per logical channel. It hosts ARQ (Automatic Repeat Request) protocol for RLC-AM mode.

3) Packet Data Convergence Protocol (PDCP) 503 in FIGS. 6-8: The PDCP sublayer presents Radio Bearers (RBs) to the SDAP sublayer. There are two types of Radio Bearers: Data Radio Bearers (DRBs) for data and Signaling Radio Bearers (SRBs) for control plane.

4) Service Data Adaptation Protocol (SDAP) 504 in FIGS. 6-8: The SDAP offers QoS Flows to the 5GC (5G Core). This sublayer provides mapping between a QoS flow and a DRB. It is used for QoS Flow to DRB mapping.

FIG. 6 is a block diagram illustrating DL L2 structure (including a scheduler or priority handling module which handles multiple UEs in a cell), in accordance with 3GPP TS 38.300. FIG. 7 is a block diagram illustrating L2 structure for a single UE, in accordance with 3GPP TS 38.300. FIG. 8 is a block diagram illustrating L2 data flow example, in accordance with 3GPP TS 38.300 (in FIG. 8, H denotes headers or sub-headers).

Open Radio Access Network (O-RAN) is based on disaggregated components which are connected through open and standardized interfaces based on 3GPP NG-RAN. An overview of O-RAN with disaggregated RAN CU (Centralized Unit), DU (Distributed Unit), and RU (Radio Unit), near-real-time Radio Intelligent Controller (Near-RT RIC) and non-real-time RIC is illustrated in FIG. 9.

As shown in FIG. 9, the CU (shown split as O-CU-CP 801a and O-CU-UP 801b) and the DU (shown as O-DU 802) are connected using the F1 interface (with F1-C for control plane and F1-U for user plane traffic) over a mid-haul (MH) path. One DU can host multiple cells (e.g., one DU could host 24 cells) and each cell may support many users. For example, one cell may support 800 Radio Resource Control (RRC)-connected users and out of these 800, there may be 250 Active users (i.e., users that have data to send at a given point of time).

A cell site can comprise multiple sectors, and each sector can support multiple cells. For example, one site could comprise three sectors and each sector could support eight cells (with eight cells in each sector on different frequency bands). One CU-CP (CU-Control Plane) could support multiple DUs and thus multiple cells. For example, a CU-CP could support 1,000 cells and around 100,000 User Equipments (UEs). Each UE could support multiple Data Radio Bearers (DRBs) and there could be multiple instances of CU-UP (CU-User Plane) to serve these DRBs. For example, each UE could support 4 DRBs, and 400,000 DRBs (corresponding to 100,000 UEs) may be served by five CU-UP instances (and one CU-CP instance).

The DU could be located in a private data center, or it could be located at a cell-site. The CU could also be in a private data center or even hosted on a public cloud system. The DU and CU, which are typically located at different physical locations, could be tens of kilometers apart. The CU communicates with a 5G core system, which could also be hosted in the same public cloud system (or could be hosted by a different cloud provider). A RU (Radio Unit) (shown as O-RU 803 in FIG. 9) is located at a cell-site and communicates with the DU via a front-haul (FH) interface.

The E2 nodes (CU and DU) are connected to the near-real-time RIC 132 using the E2 interface. The E2 interface is used to send data (e.g., user and/or cell KPMs) from the RAN, and deploy control actions and policies to the RAN at near-real-time RIC 132. The applications or services at the near-real-time RIC 132 that deploys the control actions and policies to the RAN are called xApps. During the E2 setup procedures, the E2 node advertises the metrics it can expose, and an xApp in the near-RT RIC can send a subscription message specifying key performance metrics which are of interest. The near-real-time RIC 132 is connected to the non-real-time RIC 133 (which is shown as part of Service Management and Orchestration (SMO) Framework 805 in FIG. 9) using the A1 interface. The applications that are hosted at non-RT-RIC are called rApps. Also shown in FIG. 9 are O-eNB 806 (which is shown as being connected to the near-real-time RIC 132 and the SMO Framework 805) and O-Cloud 804 (which is shown as being connected to the SMO Framework 805).

In this section, PDU sessions, DRBs, and quality of service (QoS) flows will be discussed. In 5G networks, PDU connectivity service is a service that provides exchange of PDUs between a UE and a data network identified by a Data Network Name (DNN). The PDU Connecitivity service is supported via PDU sessions that are established upon request from the UE. The DNN defines the interface to a specific external data network. One or more QoS flows can be supported in a PDU session. All the packets belonging to a specific QoS flow have the same 5QI (5G QoS Identifier). A PDU session consists of the following: Data Radio Bearer which is between UE and CU in RAN; and an NG-U GTP tunnel which is between CU-UP and UPF (User Plane Function) in the core network. FIG. 10 illustrates an example PDU session (in accordance with 3GPP TS 23.501) consisting of multiple DRBs, where each DRB can consist of multiple QoS flows. In FIG. 10, three components are shown for the PDU session 901: UE 101; access network (AN) 902; and UPF 903, which includes Packet Detection Rules (PDRs) 9031.

The following should be noted for 3GPP 5G network architecture, which is illustrated in FIG. 11 (in the context of multiple PDU sessions involving multiple DRBs and QoS Flow Identifiers (QFIs), which PDU sessions are implemented involving UE 101, gNodeB 102, UPF 903, and DNNs 9011a and 9011b):
1) The transport connection between the base station (i.e., CU-UP) and the UPF 903 uses a single GTP-U tunnel per PDU session, as shown in FIG. 11. The PDU session is identified using GTP-U TEID (Tunnel Endpoint Identifier).
2) The transport connection between the DU and the CU-UP uses a single GTP-U tunnel per DRB (see, e.g., FIG. 11).
3) SDAP:
   a) The SDAP (Service Adaptation Protocol) 504 Layer receives downlink data from the UPF 903 across the NG-U interface.
   b) The SDAP maps one or more QoS Flow(s) onto a specific DRB.
   c) The SDAP header is present between the UE 101 and the CU (when reflective QoS is enabled), and includes a field to identify the QoS flow within a specific PDU session.
4) GTP-U protocol includes a field to identify the QoS flow and is present between CU and UPF 903 (in the core network).
   FIG. 11 illustrates multiple PDU sessions involving multiple DRBs and QoS Flow Identifiers (QFIs).

In this section, standardized 5QI to QoS characteristics mapping will be discussed. As per 3GPP TS 23.501, the one-to-one mapping of standardized 5QI values to 5G QoS characteristics is specified in Table 1 shown below. The first column represents the 5QI value. The second column lists the different resource types, i.e., as one of Non-GBR, GBR, Delay-critical GBR. The third column (“Default Priority Level”) represents the priority level Priority5QI, for which the lower the value the higher the priority of the corresponding QoS flow. The fourth column represents the Packet Delay Budget (PDB), which defines an upper bound for the time that a packet may be delayed between the UE and the N6 termination point at the UPF. The fifth column represents the Packet Error Rate (PER). The sixth column represents the maximimum data burst volume for delay-critical GBR types. The seventh column represents averaging window for GBR, delay critical GBR types. Note that only a subset of 5QI values defined in 3GPP TS 23.501 are shown in Table 1 below.

For example, as shown in Table 1, 5QI value 1 represents GBR resource type with the default priority value of 20, PDB of 100 ms, PER of 0.01, and averaging window of 2000 ms. Conversational voice falls under this category. Similarly, as shown in Table 1, 5QI value 7 represents non-GBR resource type with the default priority value of 70, PDB of 100 ms and PER of 0.001. Voice, video (live streaming), and interactive gaming fall under this category.

TABLE 1

| | | Default | Packet | Packet | Default Maximum | Default | |
|---|---|---|---|---|---|---|---|
| 5QI | Resource | Priority | Delay Budget | Error | Data Burst Volume | Averaging | |
| Value | Type | Level | (NOTE 3) | Rate | (NOTE 2) | Window | Example Services |
| 1 | GBR | 20 | 100 ms | 10⁻² | N/A | 2000 ms | Conversational Voice |
| | (NOTE 1) | | (NOTE 11, | | | | |
| | | | NOTE 13) | | | | |
| 2 | | 40 | 150 ms | 10⁻³ | N/A | 2000 ms | Conversational Video |
| | | | (NOTE 11, | | | | (Live Streaming) |
| | | | NOTE 13) | | | | |
| 3 | | 30 | 50 ms | 10⁻³ | N/A | 2000 ms | Real Time Gaming, |
| | | | (NOTE 11, | | | | V2X messages (see |
| | | | NOTE 13) | | | | TS 23.287 [121]). |
| | | | | | | | Electricity distribution - |
| | | | | | | | medium voltage, |
| | | | | | | | Process automation |
| | | | | | | | monitoring |
| 4 | | 50 | 300 ms | 10⁻⁶ | N/A | 2000 ms | Non-Conversational |
| | | | (NOTE 11, | | | | Video (Buffered |
| | | | NOTE 13) | | | | Streaming) |
| 65 (NOTE 9, | | 7 | 75 ms | 10⁻² | N/A | 2000 ms | Mission Critical user |
| NOTE 12) | | | (NOTE 7, | | | | plane Push To Talk |
| | | | NOTE 8) | | | | voice (e.g., MCPTT) |
| 66 (NOTE 12) | | 20 | 100 ms | 10⁻² | N/A | 2000 ms | Non-Mission-Critical |
| | | | (NOTE 10, | | | | user plane Push To |
| | | | NOTE 13) | | | | Talk voice |
| 67 (NOTE 12) | | 15 | 100 ms | 10⁻³ | N/A | 2000 ms | Mission Critical Video |
| | | | (NOTE 10, | | | | user plane |
| | | | NOTE 13) | | | | |
| 75 (NOTE 14) | | | | | | | |
| 71 | | 56 | 150 ms | 10⁻⁶ | N/A | 2000 ms | “Live” Uplink |
| | | | (NOTE 11, | | | | Streaming (e.g. |
| | | | NOTE 13, | | | | TS 26.238 [76]) |
| | | | NOTE 15) | | | | |
| 72 | | 56 | 300 ms | 10⁻⁴ | N/A | 2000 ms | “Live” Uplink |
| | | | (NOTE 11, | | | | Streaming (e.g. |
| | | | NOTE 13, | | | | TS 26.238 [76]) |
| | | | NOTE 15) | | | | |
| 73 | | 56 | 300 ms | 10⁻⁸ | N/A | 2000 ms | “Live” Uplink |
| | | | (NOTE 11, | | | | Streaming (e.g. |
| | | | NOTE 13, | | | | TS 26.238 [76]) |
| | | | NOTE 15) | | | | |
| 74 | | 56 | 500 ms | 10⁻⁸ | N/A | 2000 ms | “Live” Uplink |
| | | | (NOTE 11, | | | | Streaming (e.g. |
| | | | NOTE 15) | | | | TS 26.238 [76]) |
| 76 | | 56 | 500 ms | 10⁻⁴ | N/A | 2000 ms | “Live” Uplink |
| | | | (NOTE 11, | | | | Streaming (e.g. |
| | | | NOTE 13, | | | | TS 26.238 [76]) |
| | | | NOTE 15) | | | | |
| 5 | Non-GBR | 10 | 100 ms | 10⁻⁶ | N/A | N/A | IMS Signalling |
| | (NOTE 1) | | NOTE 10, | | | | |
| | | | NOTE 13) | | | | |
| 6 | | 60 | 300 ms | 10⁻⁸ | N/A | N/A | Video (Buffered |
| | | | (NOTE 10, | | | | Streaming) TCP-based |
| | | | NOTE 13) | | | | (e.g., www, e-mail, chat, |
| | | | | | | | ftp, p2p file sharing, |
| | | | | | | | progressive video, etc.) |
| 7 | | 70 | 100 ms | 10⁻³ | N/A | N/A | Voice, Video |
| | | | (NOTE 10, | | | | (Live Streaming) |
| | | | NOTE 13) | | | | Interactive Gaming |

In this section, flow control between CU and DU will be discussed. In disaggregated architecture, gNB functionality is distributed among logical nodes CU-CP, CU-UP, DU and RU. DU and CU are connected through F1 interface. E1 interface connects CU-CP and CU-UP. The control plane interface F1-C is defined between CU-CP and DU, and the user plane interface F1-U is defined between CU-UP and DU. F1-U interface, the procedures and functionality of which interface are defined in 3GPP TS 38.425, supports NR User Plane (NR-UP) protocol, which provides support for flow control and reliability between CU-UP and DU. Communication over F1-U interface is achieved through exchange of three PDU types (or messages):
1) Downlink User Data (DUD) PDU from CU-UP to DU (as shown in FIG. 12): These are used to carry PDCP PDUs from CU-UP to DU for each DRB.
2) Downlink (DL) Data Delivery Status (DDDS) PDU from DU to CU-UP (as shown in FIG. 13 and FIG. 15).
   a) The DDDS message conveys Desired Buffer Size (DBS), Desired Data Rate (DDR) and some other parameters from DU to CU-UP for each DRB as part of flow control feedback. If value of the DBS is zero for a DRB, the NR PDCP hosting node (e.g., the CU-UP in this example) shall stop sending data for that DRB from the CU-UP to the DU. If value of the DBS is greater than zero, the NR PDCP hosting node (e.g., CU-UP) may send up to this amount of data for that DRB. The value of DDR is the amount of data desired to be received every second by the DU (from CU-UP) for that DRB.
   b) The corresponding node (e.g., DU in this example) can also transfer uplink data from the DU to the CU-UP for the concerned DRB along with the DDDS frame in the same GTP-U tunnel.
3) Transfer of Assistance Information (TAI) PDU from DU to CU-UP (as shown in FIG. 14).
   To recap, FIG. 12 illustrates DL user data (i.e., PDCP PDUs) from the node hosting NR PDCP 1401 (CU-UP in this example) to RLC SDU queues at the corresponding node 1402 (DU in this example). FIG. 13 illustrates DL Data Delivery Status (DDDS) PDU (flow control feedback) being sent from the corresponding node 1402 (DU in this example) to the node hosting NR PDCP 1401 (CU-UP in this example) for each DRB. FIG. 14 illustrates transfer of (Radio) Assistance Information from the corresponding node 1402 (DU in this example) to the node hosting NR PDCP 1401 (CU-UP in this example).

CU-UP sends PDCP PDUs to DU using NR-UP protocol. Each such PDCP PDU is carried using data PDU format (shown in FIG. 15), and NR-U Sequence Number (NR-U SN) is added to each such data PDU. In the present disclosure, “NR-U SN” and “NR-UP SN” are used interchangeably. The DDDS message (shown in FIG. 16) conveys, among other information, Desired Buffer Size (DBS) in bytes, and Desired Data Rate (DDR) in units of bytes/second from DU to CU-UP. If the value of the DBS is zero for a DRB, the NR PDCP hosting node (e.g., the CU-UP in this example) shall stop sending data for that DRB from the CU-UP to the DU. If the value of the DBS is greater than zero, the NR PDCP hosting node (e.g., CU-UP) may send up to this amount of data for that DRB. The value of DDR is the amount of data desired to be received every second by the DU (from CU-UP) for that DRB. FIG. 16 illustrates the details of DL Data Delivery Status (DDDS) sent from the corresponding node (DU in this example) to the node hosting NR PDCP (CU-UP in this example).

In this section, CU-DU flow control issues caused by midhaul impairments will be discussed. Usually, the air interface is the bottleneck in a mobile wireless network, and thus conventional flow control mechanisms will be based only on air-interface impairments. However, in certain deployments, MH can also become a potential bottleneck. The midhaul (MH) transport network that connects CU-UP with DU can consist of optical fibers, switches and routers. Occasionally, due to busy-hour conditions or transient traffic spike events, switches and/or routers drop packets to avoid congestion in the network. The MH transport network can also be based on microwave links, which are susceptible to adverse (and/or unpredictable) radio channel conditions, and such networks can have higher packet drop rate compared to MH based on optical fibers. When the dropped packets are NR-UP PDUs, they manifest at DU as NR-U SN losses, resulting in DU requesting retransmissions from CU-UP. Retransmissions lead to increased delay over the midhaul. In the case of applications designed over TCP, the source application can reduce the transmission rate, thus adversely affecting the application performance. In some cases (or over some time intervals), midhaul losses are so high that the midhaul becomes the bottleneck link, and the air interface is no longer the bottleneck link in the 5G network. However, conventional mitigation technique for MH impairments on flow control mechanisms is limited to retransmission mechanisms over the MH network.

Accordingly, there is a need for a system and method to achieve an improved CU-DU flow control optimization for lossy midhaul (MH) in O-RAN networks.

### SUMMARY

Accordingly, what is desired is a system and method to optimize CU-DU flow control methods to detect the congestion events over midhaul and proactively take corrective action to reduce packet dropping in the midhaul transport network.

According to an example method (“Method 1”), DDR is computed for each DRB and sent every time when DBS is sent from DU to CU-UP (along with DDDS).

According to an example sub-variant of Method 1, DU computes DDR for a DRB as follows:

DDR=TBS (MCS″,prb″,rank)*(number of slots/subframe in 1 sec)*(beta)*(beta_drb)

with TBS being the Transport block size computation as per 3GPP TS 38.214 section 5.1.3 and TS 36.213 section 7.1.7, and MCS″=min {(current MCS+MCS_step), MCSmax}.

According to an example sub-variant of Method 1, DU computes DDR for a DRB as follows:

DDR=TBS (MCS″, prb″, rank)*(number of slots/subframe in 1 sec)*(beta)*(beta_drb)

with TBS being the Transport block size computation as per 3GPP TS 38.214 section 5.1.3 and TS 36.213 section 7.1.7, and MCS″=min {(average MCS+MCS_step), MCSmax}.

According to an example method (“Method 2”), DU estimates the effective data rate at which CU-UP can send data for each DRB to reduce congestion over midhaul. This estimation can be split into two sequential steps:
Step 1: DU estimates the DDR as in Method 1.
Step 2: DU will reduce its DDR estimate arrived in Step 1 by a value δ (i.e., effective DDR=DDR−δ) that depends on the estimates of lost downlink NR-UP SNs in the latest interval of time T (for example, T could be 100 ms):

According to an example method (“Method 3”), CU-UP utilizes information obtained from the DDDS message to compute effective DDR to mitigate packet losses over the midhaul.

According to an example sub-variant of Method 3, CU-UP learns about congestion on the midhaul from the DDDS PDUs received from DU. The protocol fields “Number of lost NR-U Sequence Number ranges reported”, “Start of lost NR-U Sequence Number range”, and “End of lost NR-U Sequence Number range” of the DDDS PDU provide information about lost NR-UP SNs.

According to an example sub-variant of Method 3, CU-UP can update the received DDR by subtracting a value, e.g., F, from the received DDR, which value F can depend on information on lost NR-UP SNs in the latest interval of time T1. The steps of the second sub-variant of Method 3 are as follows:
Step 1: DU estimates the DDR as in Method I and sends it to CU-UP.
Step 2: CU-UP will reduce the DDR obtained in Step 1 by a value ε (i.e., effective DDR=DDR−ε) that depends on the estimates of lost downlink NR-UP SNs in the latest interval of time T (for example, T1 could be 100 ms). CU-UP obtains knowledge about these lost NR-UP SNs based on the retransmission request received as part of DDDS message from DU.

According to an example method (“Method 4”), redundant reduction of the effective transmission rate by both DU and CU-UP is avoided by DU utilizing a spare flag in the DDDS PDU (as per 3GPP TS 38.425) to inform CU-UP that its DDR estimate has already factored in the MH packet loss rate.

For this application the following terms and definitions shall apply:

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The above-described and other features and advantages of the present disclosure will be appreciated and understood by those skilled in the art from the following detailed description, drawings, and appended claims.

### DESCRIPTION OF THE DRAWINGS

FIG. 1 is a block diagram illustrating the user plane stack of 5G NR.

FIG. 2 is a block diagram illustrating the user plane protocol stacks for a PDU session of 5G NR.

FIG. 3 is a block diagram illustrating the control plane stack of 5G NR.

FIG. 4 is a block diagram illustrating NG-RAN architecture.

FIG. 5 is a block diagram illustrating separation of CU-CP and CU-UP in NG-RAN architecture.

FIG. 6 is a block diagram illustrating DL L2 structure.

FIG. 7 is a block diagram illustrating UL L2 structure.

FIG. 8 is a block diagram illustrating L2 data flow example.

FIG. 9 illustrates an overview of O-RAN architecture.

FIG. 10 illustrates an example PDU session consisting of multiple DRBs.

FIG. 11 illustrates multiple PDU sessions involving multiple DRBs and QoS Flow Identifiers (QFIs).

FIG. 12 illustrates DL user data (i.e., PDCP PDUs) from the node hosting NR PDCP (CU-UP in this example) to the corresponding node (DU in this example).

FIG. 13 illustrates DL Data Delivery Status (DDDS) PDU being sent from the corresponding node (DU in this example) to the node hosting NR PDCP (CU-UP in this example).

FIG. 14 illustrates transfer of Assistance Information from the corresponding node (DU in this example) to the node hosting NR PDCP (CU-UP in this example).

FIG. 15 illustrates the PDU format of PDCP PDU sent from CU-UP to DU using NR-UP protocol.

FIG. 16 illustrates the details of DL Data Delivery Status (DDDS) sent from the corresponding node (DU in this example) to the node hosting NR PDCP (CU-UP in this example) for each DRB.

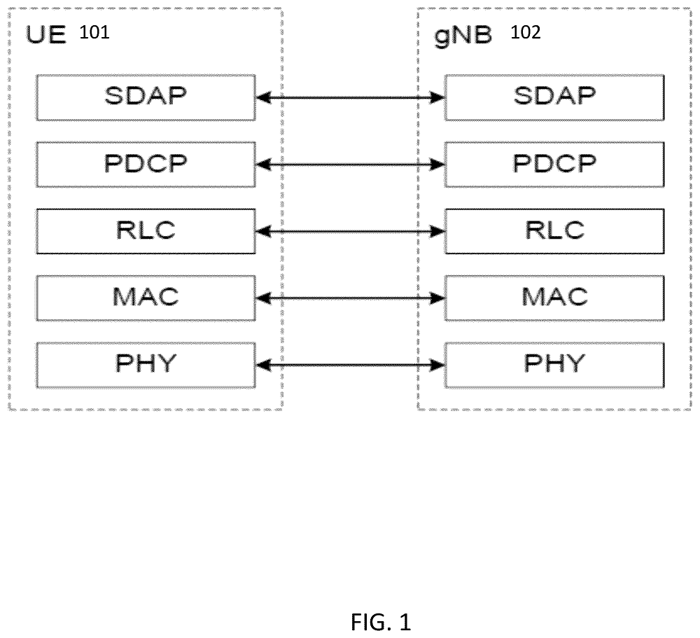

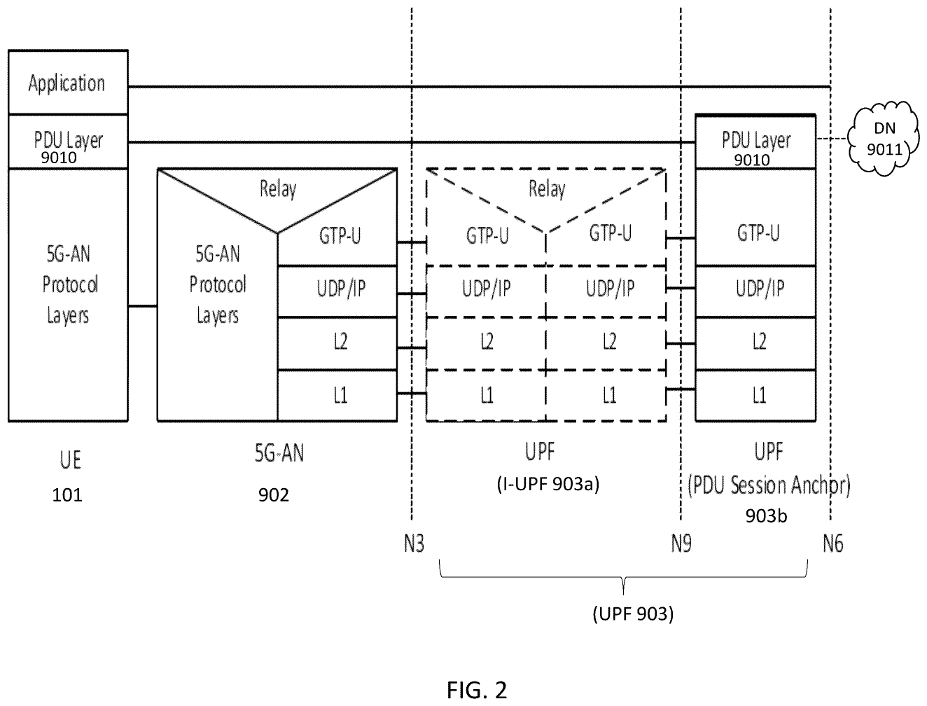

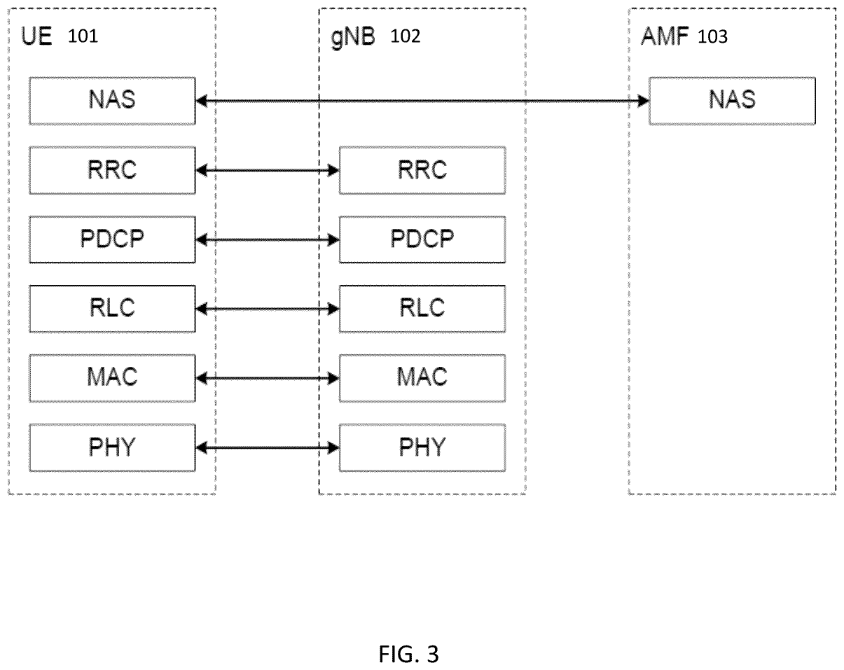

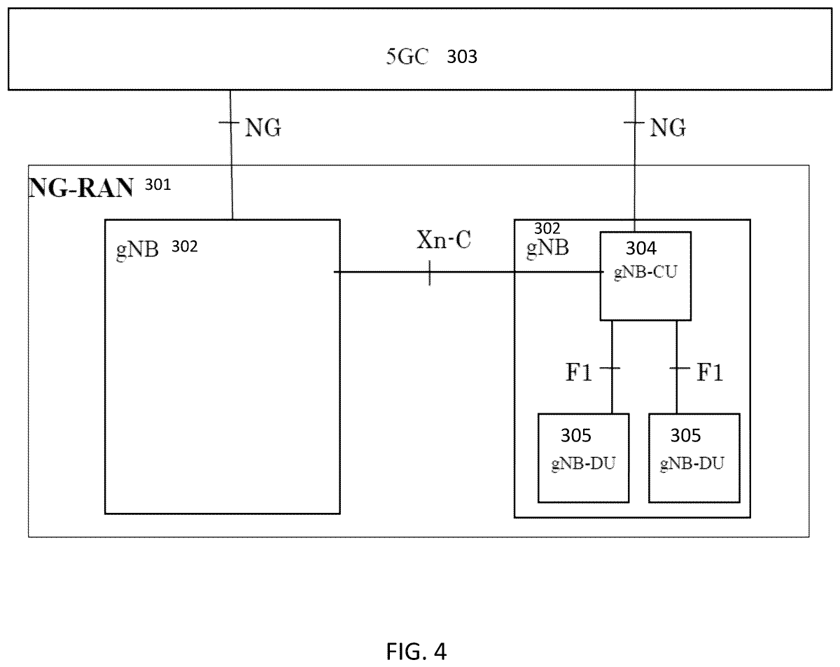

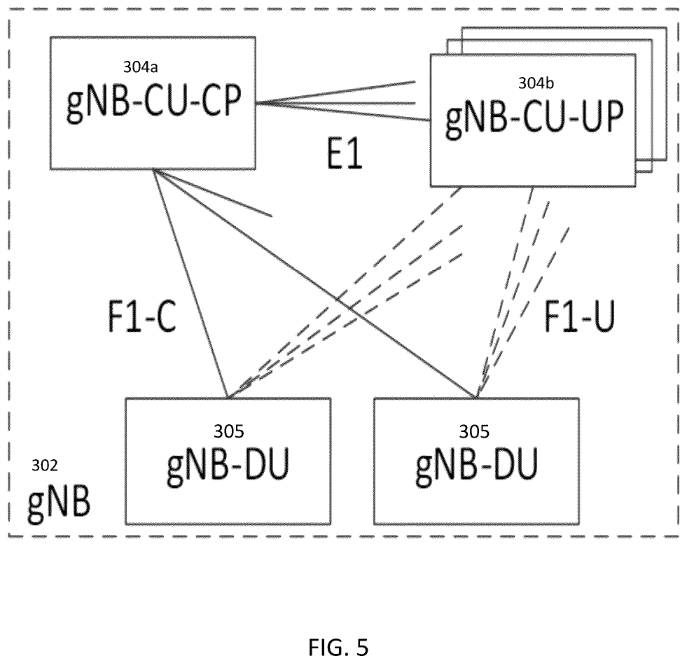

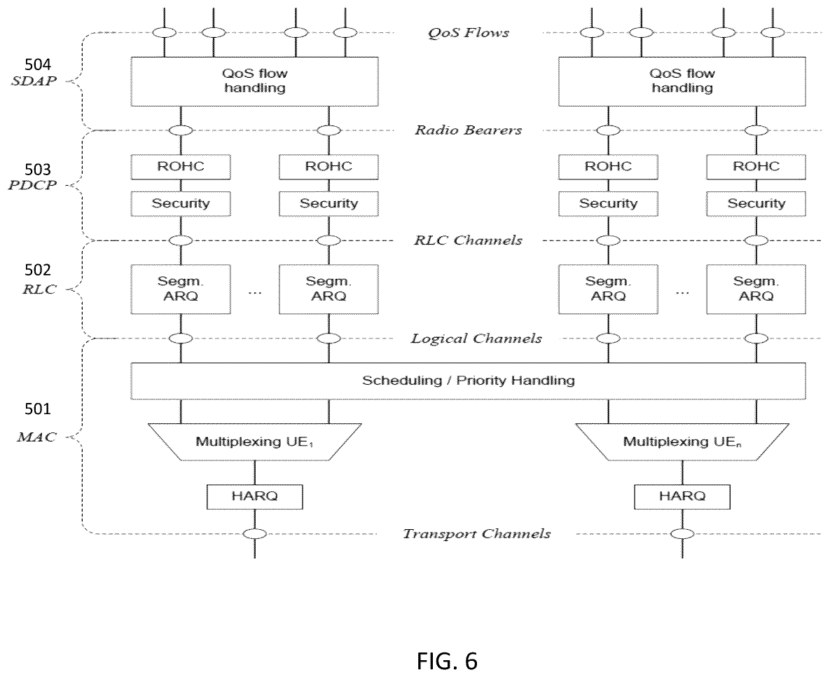

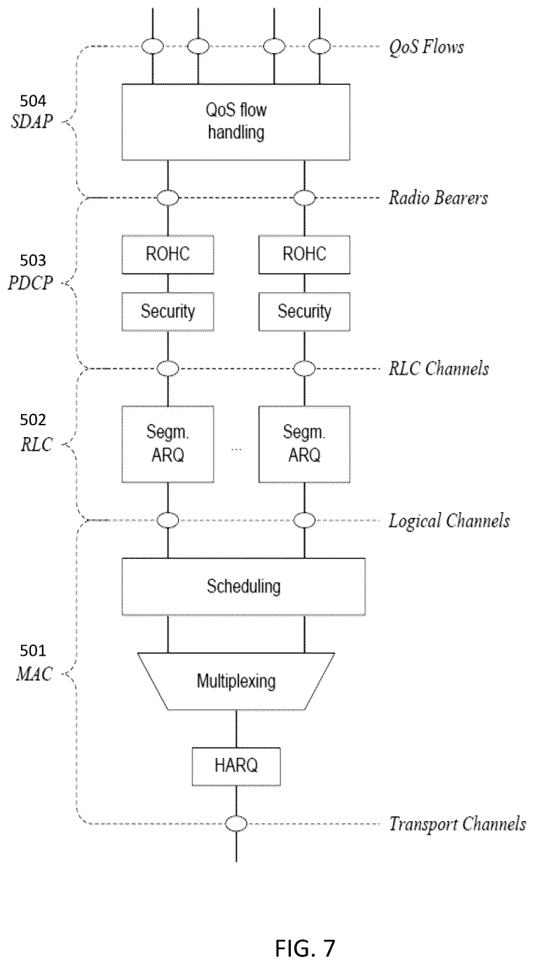

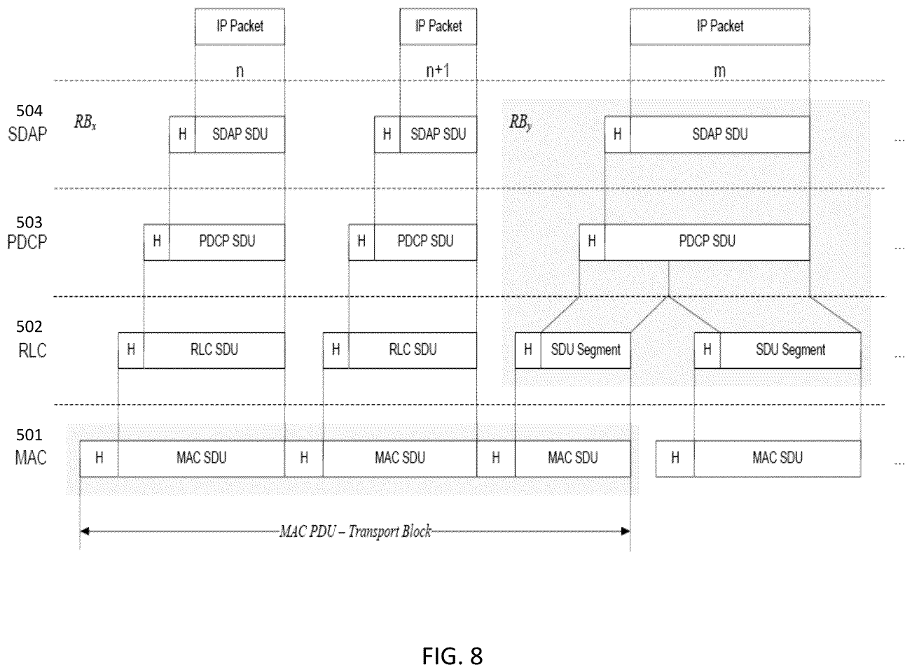

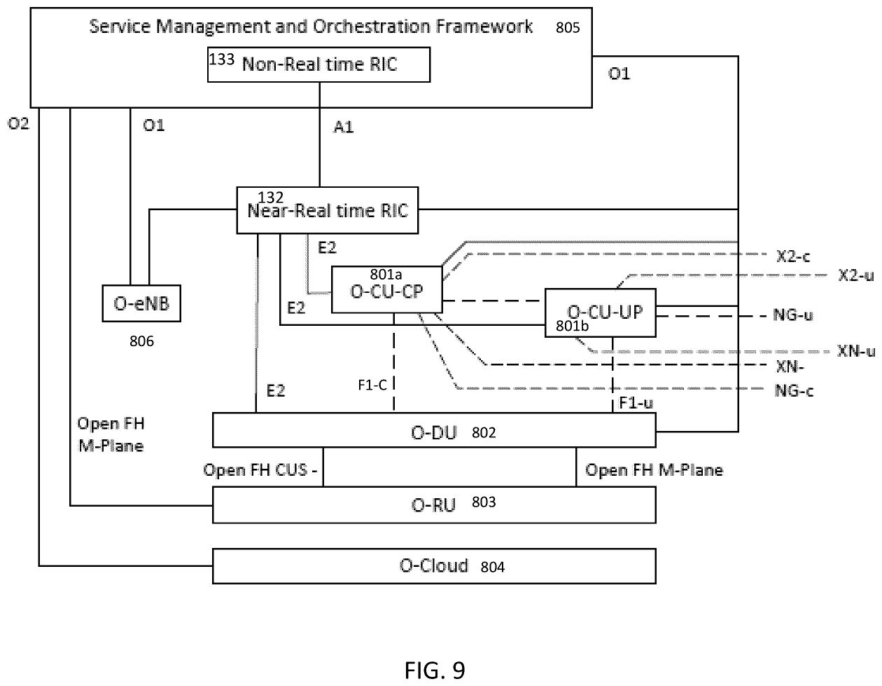

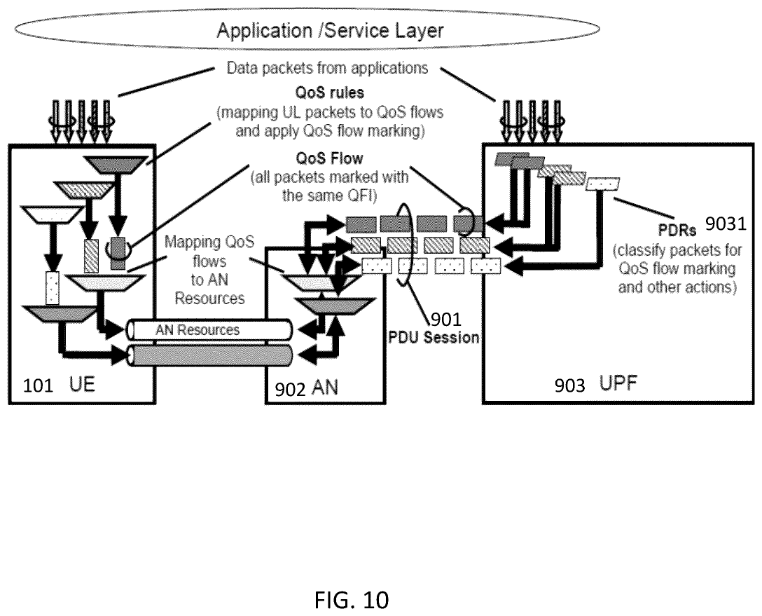

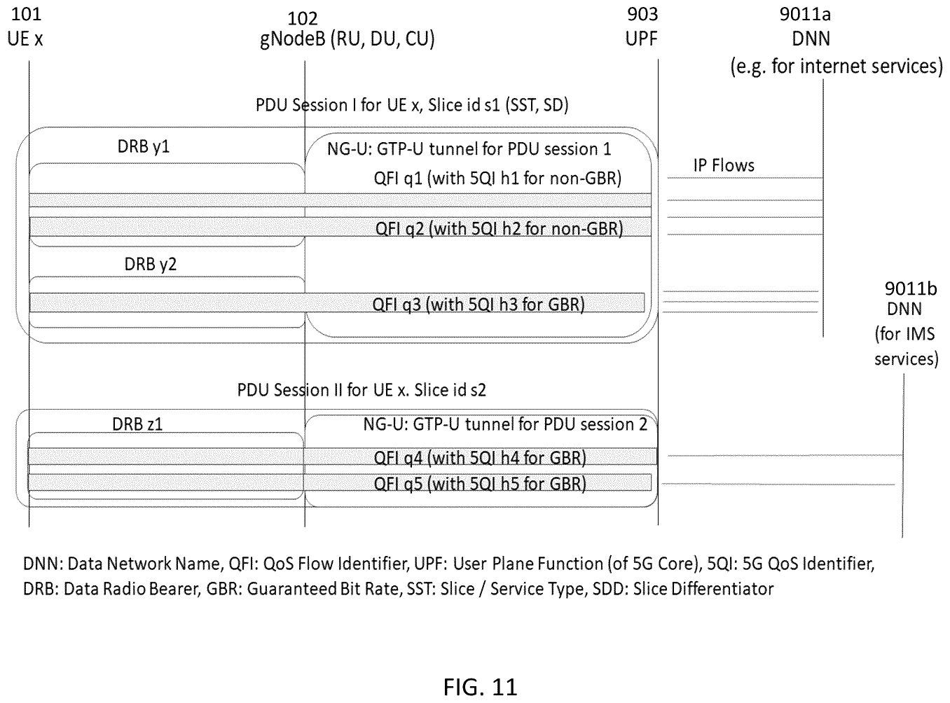

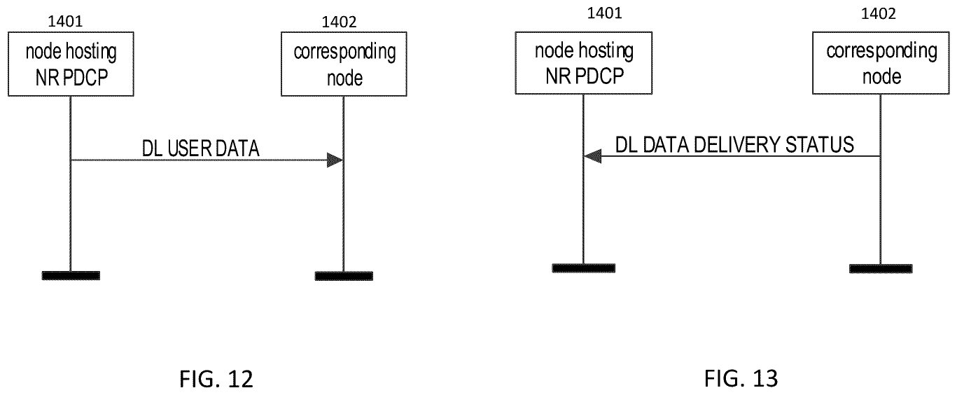

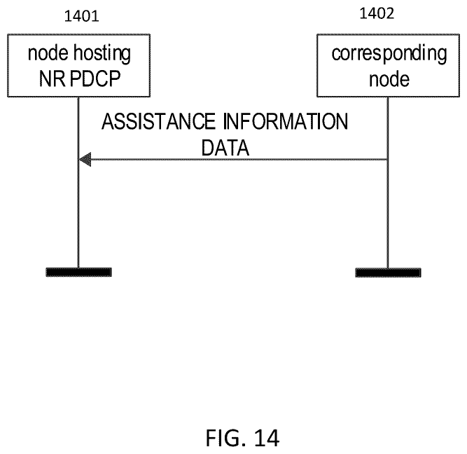

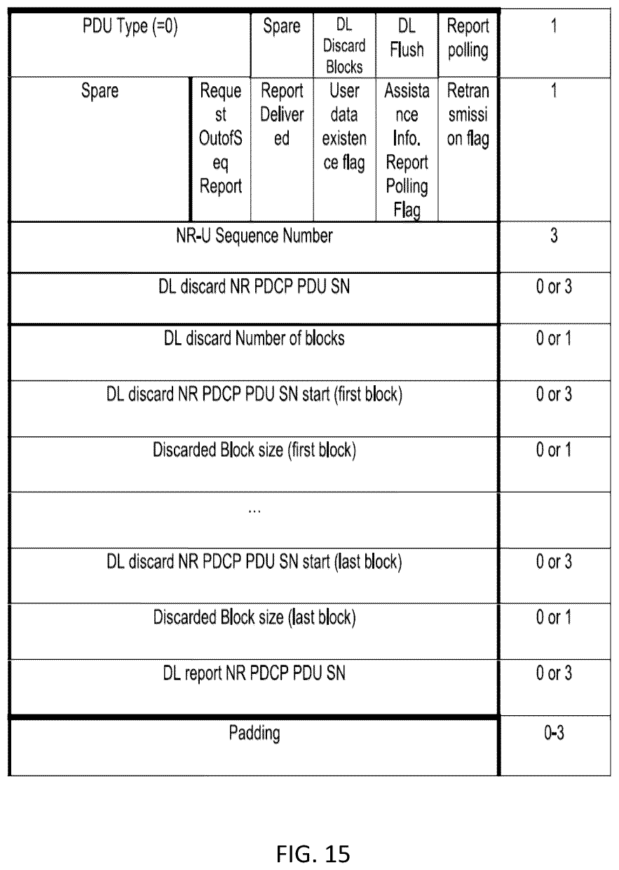

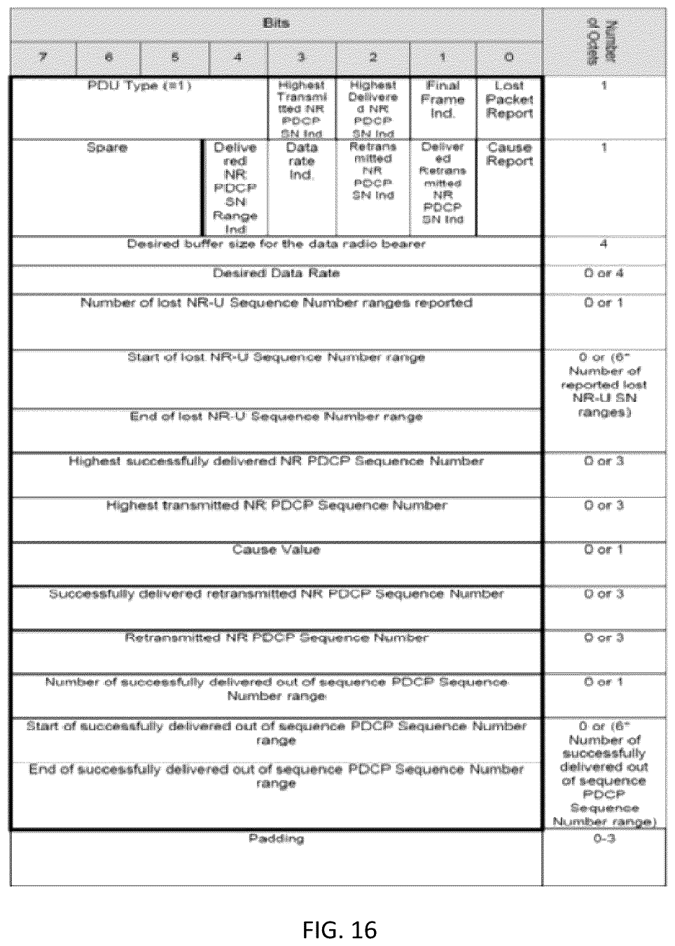

### DETAILED DESCRIPTION

In an example embodiment of the method (“Method 1”) according to the present disclosure, computation of desired data rate (DDR) is provided. According to this example method, DDR is computed for each DRB and sent every time when DBS is sent from DU to CU-UP (along with DDDS). In a first sub-variant this example method, DU computes DDR for a DRB as follows:

DDR=TBS (MCS″, prb″, rank)*(number of slots/subframe in 1 sec)*(beta)*(beta_drb)

Here, TBS is the Transport block size computation as per 3GPP TS 38.214 section 5.1.3 and TS 36.213 section 7.1.7.

$$MCS ’ ’ = min \{ ( current MCS + MCS\_step ) , MCS max \} .$$

MCS_step is a correction factor for current MCS.
Range of MCS_step: [−4,4].
MCS_Step is positive or negative based on CQI consistency. If UE is reporting high CQI consistently, then MCS step is positive, else it is negative.
Current MCS is instantaneous current value of modulation and coding
scheme (MCS) at a current time instant t.
MCSmax is the maximum MCS possible in a given system.

$$prb ’ ’ = max ( \frac{{PRB}_{max}}{{\#UE}_{s}} , {PRB}_{avg} , 1 )$$

Here, PRB_avg is the average number of PRBs allocated to UE counting all DL slots.
#UEs is the number of active UEs in the cell.
PRBₘₐₓ is the maximum number of possible PRBs in the cell.
rank is the number of layers in PDSCH at a given time.
beta is a scaling factor, which depends upon, e.g., behavior of midhaul links, number of component carriers used for carrier aggregation, buffer management policies used in the DU, etc.
A UE could have multiple DRBs. In that case, DDR for each individual DRB is computed using a scaling factor, beta_drb, as used above.

In a second sub-variant of the example method in which DDR is computed for each DRB and sent every time when DBS is sent from DU to CU-UP (along with DDDS), DU computes DDR for a DRB as follows:

$$DDR = TBS ( MCS ’ ’ , prb ’ ’ , rank ) * ( number of slots / subframe in 1 sec ) * ( beta ) * ( beta\_drb )$$

Here, TBS is the Transport block size computation as per 3GPP TS 38.214 section 5.1.3 and TS 36.213 section 7.1.7.

$$MCS ’ ’ = min \{ ( average {MCS}_{current} + MCS\_step ) , MCS max \} .$$

MCS_step is a correction factor for average MCS(current).
Range of MCS_step: [−1,0,1].
MCS_Step is positive or negative based on CQI consistency. If UE is reporting high CQI consistently, then MCS step is positive, else it is negative or zero.
Weighted average MCS (denoted as “avgMCS_{current}”) of the UE is computed as follows:

$${avgMCS}_{current} = {avgMCS}_{previous} * ( 1 - alpha ) + current MCS * alpha .$$

Here, alpha is between 0 and 1.
avgMCS_{current} is the current weighted average of MCS (e.g., at time t).
avgMCSₚᵣₑᵥᵢₒᵤₛ is the weighted average of MCS at a previous time instant (at time t-1 if we last computed avgMCS at time t-1).
current MCS is the instantaneous current value of modulation and coding scheme (MCS) at a current time instant t.
MCSmax is the maximum MCS possible in a given system.

$${avgMCS}_{current} = {avgMCS}_{previous} * ( 1 - alpha ) + current MCS * alpha .$$

Here, PRB_avg is the average number of PRBs allocated to UE counting all DL slots.
#UEs is the number of active UEs in the cell,
PRBₘₐₓ is the maximum number of possible PRBs in the cell.
rank is the number of layers in PDSCH at a given time.
beta is a scaling factor, which depends upon, e.g., behavior of backhaul and/or midhaul links, carrier aggregation, buffer management policies used in the DU, etc.
A UE could have multiple DRBs. In that case, DDR for each individual DRB is computed using a scaling factor, beta_drb, as used above.

In the above-described first and second sub-variants of Method 1, the range of beta could be [n1, n2], with n2 greater than or equal to n1. For some deployments, e.g., in scenarios with a relatively good midhaul and enough buffer space available in DU, beta could be equal or greater than one. In this scenario, it may be desired to transfer data (i.e., PDCP PDUs) from CU-UP to DU as soon as possible. For other deployment scenarios, e.g., with midhaul behaving poorly during a transient period, beta could be chosen to be less than one during that transient period. Thus, the value of beta can change during the life cycle of a DRB for which flow control is being applied. In addition, a UE could have multiple DRBs. In that case, DDR for each individual DRB is computed using a scaling factor, beta_drb, as used above. For example, if there are two DRBs of same 5QI (e.g., 5QI 9) and both DRBs support similar data rate, value of beta_drb could be set to 0.5.

In a second example embodiment of the method (“Method 2”) according to the present disclosure, DU estimates the effective data rate at which CU-UP can send data for each DRB to reduce congestion over midhaul. This estimation can be split into two sequential steps.
Step 1: DU estimates the DDR as in Method 1.
Step 2: DU will reduce its DDR estimate arrived in Step 1 by a value δ (i.e., effective DDR=DDR−δ) that depends on the estimates of lost downlink NR-UP SNs (corresponding to NR-UP PDUs) in the latest specified time interval T (for example, T could be 100 ms):
   a) If no downlink PDCP PDUs (and the corresponding NR-UP PDUs) were lost over the mid-haul in this interval T, effective DRR is set to DDR as computed at DU in Method 1 (and communicated to CU-UP through the DDDS message).
   b) If there are losses over mid-haul, Method 2 makes δ proportional to the loss-rate estimation.
      i. If number of NR-UP SN losses over mid-haul keeps increasing over successive time intervals of duration T, we decrease δ aggressively to compute effective DDR.
      ii. For example, assume that n₁ NR-UP PDUs are lost since the last DDR computation. Let δ(n₁) be the amount by which DDR estimate of Step 1 is reduced to calculate the effective DDR. After a short while (say, after time T), DU learns that n₂ NR-UP PDUs are lost. If n₂>>n₁, then we make δ(n₂)>>δ(n₁). δ(n₂) will be unchanged if n₂ is approximately equal to n₁.
      iii. It should be noted that effective DDR is not allowed to go below a pre-specified threshold.

In Method 2, DU also uses one more trigger to send DDDS to CU-UP. Once DU discovers that the number of downlink packets lost (e.g., based on NR-UP SN losses) over midhaul is above a specified threshold, DU immediately sends DDDS (with updated DDR) to CU-UP.

When packet loss ratio estimate at DU is more than a configurable threshold, DU will send DDR (and DDDS) more frequently than when the loss ratio (e.g., based on NR-UP SN losses) is less than the threshold. This can be generalized by letting DU define multiple thresholds, where each threshold will signify switch from one reporting frequency to the other reporting frequency depending on whether the packet loss ratio is increasing or decreasing.

After a short while, midhaul network may get decongested resulting in smaller packet loss ratio estimate at DU. In such a scenario, DU will revert to the earlier reporting frequency at which it used to feedback DDR. Thus, the time duration between two successive DDDS messages will depend on the midhaul packet loss ratio estimate, in addition to other events and causes.

In a third example embodiment of the method (“Method 3”) according to the present disclosure, CU-UP utilizes information obtained from the DDDS message to compute effective DDR to mitigate packet losses over the midhaul. In a first sub-variant of Method 3, CU-UP learns about congestion on the midhaul from the DDDS PDUs received from DU. The protocol fields “Number of lost NR-U Sequence Number ranges reported”, “Start of lost NR-U Sequence Number range”, and “End of lost NR-U Sequence Number range” of the DDDS PDU provide information about lost NR-UP SNs. Let Bₙ denote the highest lost NR-UP SN reported by the n^{th} DDDS PDU, and t(Bₙ) denote the time instant at which CU-UP has transmitted the NR-UP SN Bₙ. Upon the reception of the n^{th} DDDS PDU, CU-UP will learn feedback information (which SNs are received/lost) about the following NR-UP SNs: {Bₙ₋₁+1, Bₙ₋₁+2, . . . , Bₙ}.

An example of the above-described sub-variant is provided below. Let Bₙ₋₁=500 and Bₙ=1500. Assume that the n^{th} DDDS PDU has reported four NR-UP SN ranges [725, 756], [834, 849], [952, 965], and [1480, 1500] as being lost. Then the n^{th} DDDS PDU is providing feedback information about the following NR-UP SNs: {501, 502, . . . , 1498, 1499, 1500}. Of these, the lost NR-UP SNs are 32 SNs corresponding to the range [725, 756], 16 SNs corresponding to the range [834, 849], 14 SNs corresponding to the range [952, 965], and 21 SNs corresponding to the range [1480, 1500]. Thus, a total of 83 NR-UP SNs are lost on the midhaul out of 1001 SNs corresponding to the range [500, 1500]. Let the NR-UP SNs in the set {Bₙ₋₁+1, Bₙ₋₁+2, . . . , Bₙ}correspond to totTxBytesₙ PDCP bytes. Of these, let the number of lost bytes be denoted by lostBytesₙ. Then define sustainable rate at CU-UP=(totTxBytesₙ−lostBytesₙ)/[t(Bₙ)−t(Bₙ₋₁)]. So far, we have discussed the rate that the midhaul network can support without packet loss. However, assuming the “Desired Data Rate” field of the DDDS PDU is present in the DDDS PDU, the actual rate at which CU-UP shall transmit PDCP PDUs is the minimum of sustainable rate and the Desired Data Rate.

In this example embodiment, CU-UP determines the data rate to transmit to DU as follows:

{
If(“Desired Data Rate” field in DDDS is included}
{
$CU - UP will transmit at min \{ DDR , \frac{{totTxBytes}_{n} - {lostBytes}_{n}}{t ( {B}_{n} ) - t ( {B}_{n} - 1 )} ( “ bytes / second ” ) \}$
Else
{
$CU - UP will transmit at the rate \frac{{totTxBytes}_{n} - {lostBytes}_{n}}{t ( {B}_{n} ) - t ( {B}_{n} - 1 )} ( bytes / second )$
}
}

Note that above method is used only when relevant parameters are available in the DDDS message.

In a second sub-variant of Method 3, CU-UP can update the received DDR by subtracting a value, e.g., ε, from the received DDR, which value F can depend on information on lost NR-UP SNs in the latest interval of time T1. The steps of the second sub-variant of Method 3 are as follows:
Step 1: DU estimates the DDR as in Method I and sends it to CU-UP.
Step 2: CU-UP will reduce the DDR obtained in Step 1 by a value ε (i.e., effective DDR=DDR−ε) that depends on the estimates of lost downlink NR-UP SNs in the latest interval of time T (for example, T1 could be 100 ms). CU-UP obtains knowledge about these lost NR-UP SNs based on the retransmission request received as part of DDDS message from DU.
   a) If there is no request to retransmit PDCP PDUs (and the corresponding NR-UP PDUs) in the DDDS message (over interval T1), effective DDR at CU-UP is set to DDR as received from DU.
   b) If there are retransmission requests received as part of DDDS message, then E is set proportional to the loss-rate estimation.
      i. If the requested number of NR-UP SN keeps increasing over successive time intervals of duration T1, ε is decreased aggressively to compute effective DDR at CU-UP. For example, let's assume that DU has requested to retransmit n₁ NR-UP PDUs since the last effective DDR computation. Let ε (n₁) be the amount by which DDR estimate of Step 1 is reduced to calculate the effective DDR. After a short while (e.g., after time T1), CU-UP learns that DU has requested to retransmit n₂ NR-UP PDUs. If n₂>>n₁, then we make ε (n₂)>>ε (n₁). ε (n₂) will be unchanged if n₂ is approximately equal to n₁.

It should be noted that the effective DDR is not allowed to go below a pre-specified threshold.

A fourth example embodiment of the method (“Method 4”) according to the present disclosure can be implemented for a scenario in which no coordination exists between CU-UP and DU regarding which entity should compute the packet loss rate. In this scenario, CU-UP and DU, unaware of each other's decision to estimate the packet loss rate, can redundantly reduce the effective transmission rate as follows: i) DU computes “effective” DDR by factoring in the packet loss rate and sends it in the DDDS message; and ii) unaware of this, CU-UP may independently estimate the packet loss rate and make the transmission rate from CU-UP to DU much less than the received DDR. To avoid such a situation, in Method 4, DU utilizes a spare flag in the DDDS PDU (as per 3GPP TS 38.425) to inform CU-UP that its DDR estimate has already factored in the MH packet loss rate. This flag can be referred to as “Loss Rate Modulated DDR”. This flag will be set when DU has factored in the packet loss rate while computing the DDR. If this flag is set, CU-UP uses the DDR as communicated by DU, and doesn't update DDR on its own for a pre-specified time interval.

While the present disclosure has been described with reference to one or more exemplary embodiments, it will be understood by those skilled in the art that various changes may be made and equivalents may be substituted for elements thereof without departing from the scope of the present disclosure. For example, although the example methods have been described in the context of 5G cellular networks, the example methods are equally applicable for 4G and other similar wireless networks. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

For the sake of completeness, a list of abbreviations used in the present specification is provided below:
3GPP: 3rd Generation Partnership Project
5GC: 5G Core Network
5G NR: 5G New Radio
5QI: 5G QoS Identifier
ACK: Acknowledgement
AM: Acknowledged Mode
APN: Access Point Name
ARP: Allocation and Retention Priority
BS: Base Station
CP: Control Plane
CQI: Channel Quality Indicator
CU: Centralized Unit
CU-CP: Centralized Unit-Control Plane
CU-UP: Centralized Unit-User Plane
DBS: Desired Buffer Size
DL: Downlink
DDDS: DL Data Delivery Status
DDR: Desired Data Rate
DNN: Data Network Name
DRB: Data Radio Bearer
DU: Distributed Unit
eNB: evolved NodeB
EPC: Evolved Packet Core
GBR: Guaranteed Bit Rate
gNB: gNodeB
GTP-U: GPRS Tunneling Protocol-User Plane
IP: Internet Protocol
L1: Layer 1
L2: Layer 2
L3: Layer 3
L4S: Low Latency, Low Loss and Scalable Throughput
LC: Logical Channel
MAC: Medium Access Control
MCS: Modulation and Coding Scheme
NACK: Negative Acknowledgement
NAS: Non-Access Stratum
NR-U SN: New Radio-User Plane, Sequence Number
NR-UP SN: New Radio-User Plane, Sequence Number. (Used interchangeably with NR-U SN)
NSI: Network Slice Instance
NSSI: Network Slice Subnet Instance
O-RAN: Open Radio Access Network
PDB: Packet Delay Budget
PDCP: Packet Data Convergence Protocol
PDU: Protocol Data Unit
PHY: Physical Layer
PRB: Physical Resource Block
QCI: QoS Class Identifier
QFI: QoS Flow Id
QoS: Quality of Service
QFI: QoS Flow Identifier
RAT: Radio Access Technology
RDI: Reflective QoS Flow to DRB Indication
RLC: Radio Link Control
RLC-AM: RLC Acknowledged Mode
RLC-UM: RLC Unacknowledged Mode
RQI: Reflective QoS Indication
RRC: Radio Resource Control
RRM: Radio Resource Management
RTP: Real-Time Transport Protocol
RTCP: Real-Time Transport Control Protocol
RU: Radio Unit
SCTP: Stream Control Transmission Protocol
SD: Slice Differentiator
SDAP: Service Data Adaptation Protocol
SLA: Service Level Agreement
S-NSSAI: Single Network Slice Selection Assistance
SNL Sequence Number
SST: Slice/Service Type
TB: Transport Block
TCP: Transmission Control Protocol
TEID: Tunnel Endpoint Identifier
UE: User Equipment
UP: User Plane
UL: Uplink
UM: Unacknowledged Mode
UPF: User Plane Function

1. A method for optimizing midhaul flow control between a control unit (CU) and a distributed unit (DU) of an Open Radio Access Network (O-RAN), comprising:
computing, by the DU, desired data rate (DDR) for each data radio bearer (DRB); and
sending, by the DU, the DDR every time when desired buffer size (DBS) is sent from DU to CU-user plane (CU-UP), along with Downlink Data Delivery Status (DDDS);
wherein the DU computes DDR for a DRB as follows:
DDR=TBS (MCS″, prb″, rank)*(number of slots in 1 sec)*(beta)*(beta_drb), with TBS being the transport block size computation, and wherein one of:
$$prb ’ ’ = max ( \frac{{PRB}_{max}}{{\#UE}_{s}} , {PRB}_{avg} , 1 )$$
wherein current MCS is an instantaneous current value of MCS at a current time instant t, avgMCS_{current} is current weighted average MCS at a current time instant t, MCSmax is the maximum possible MCS, and MCS_Step is a correction factor for the current MCS and the average MCS_{current}, and MCS_Step is one of positive or negative depending on channel quality indicator (CQI) consistency.

2. The method of claim 1, wherein for b) MCS″=min {(average MCS(current)+MCS_step), MCSmax}, current weighted average MCS at a current time instant t, avgMCS_{current}, of a user equipment (UE) is computed as follows:
$$a ) MCS ’ ’ = min \{ ( current modulation and coding scheme ( current MCS ) + MCS\_step ) , MCS max \} , or$$
$$b ) MCS ’ ’ = min \{ ( average {MCS}_{current} + MCS\_step ) , MCS max \} ,$$
wherein alpha is between 0 and 1, and avgMCSₚᵣₑᵥᵢₒᵤₛ is a weighted average of MCS at previous time instant t-1.

3. The method of claim 1, wherein:
$${avgMCS}_{current} = {avgMCS}_{previous} * ( 1 - alpha ) + current MCS * alpha ,$$
PRB_avg is the average number of physical resource blocks (PRBs) allocated to UE counting all downlink (DL) slots, #UEs is the number of active UEs in the cell, and PRBₘₐₓ is the maximum number of possible PRBs in the cell.

4. The method of claim 1, wherein:
$$prb ’ ’ = max ( \frac{{PRB}_{max}}{{\#UE}_{s}} , {PRB}_{avg} , 1 ) ,$$
PRB_avg is the average number of physical resource blocks (PRBs) allocated to UE counting all downlink (DL) slots, #UEs is the number of active UEs in the cell, and PRBₘₐₓ is the maximum number of possible PRBs in the cell.

5. The method of claim 1, further comprising:
reducing, by the DU, the computed DDR for a DRB by a reduction value δ which depends on an amount of loss of downlink (DL) new radio user-plane sequence numbers (NR-UP SNs) in a specified time interval over a midhaul connection between the CU and the DU.

6. The method of claim 5, further comprising:
at least one of:
i) sending, by the DU to the CU-UP, a flag along with the DDDS to indicate the computed DDR has been reduced to reflect the loss of DL NR-UP SNs;
ii) sending, by the DU to the CU-UP, the DDDS after the DU discovers that the amount of loss of DL NR-UP SNs in the specified time interval over the midhaul connection between the CU and DU is above a specified threshold; and
iii) adjusting, by the DU, a frequency of sending the DDDS, depending on whether packet loss ratio estimate at DU based on the amount of loss of DL NR-UP SNs in the specified time interval over the midhaul connection between the CU and DU is above a specified threshold.

7. The method of claim 1, further comprising:
reducing, by the CU-UP, the received DDR for a DRB by a reduction value ε which depends on an amount of loss of downlink (DL) new radio user-plane sequence numbers (NR-UP SNs) in a specified time interval over a midhaul connection between the CU and the DU.

8. The method of claim 1, further comprising:
computing, by the CU-UP, an effective DDR for a DRB based on the received DDR and information derived from the DDDS regarding a proportion of lost DL NR-UP SNs relative to transmitted NR-UP SNs in a specified time interval over a midhaul connection between the CU and the DU, wherein the effective DDR is the minimum value between i) the received DDR and ii) the proportion of lost DL NR-UP SNs relative to transmitted NR-UP SNs in the specified time interval.

9. A system for optimizing midhaul flow control in an Open Radio Access Network (O-RAN), comprising:
a centralized unit (CU) comprising a CU user plane (CU-UP); and
a distributed unit (DU) configured to i) compute a desired data rate (DDR) for each data radio bearer (DRB), and ii) send the DDR every time when desired buffer size (DBS) is sent from the DU to the CU-UP, along with Downlink Data Delivery Status (DDDS);
wherein the DU is configured to compute the DDR for a DRB as follows:
DDR=TBS (MCS″, prb″, rank)*(number of slots in 1 sec)*(beta)*(beta_drb), with TBS being the transport block size computation, and wherein one of:
$$a ) MCS ’ ’ = min \{ ( current modulation and coding scheme ( current MCS ) + MCS\_step ) , MCS max \} , or$$
$$b ) MCS ’ ’ = min \{ ( average {MCS}_{current} + MCS\_step ) , MCS max \} ,$$
wherein current MCS is an instantaneous current value of MCS at a current time instant t, avgMCS_{current} is current weighted average MCS at a current time instant t, MCSmax is the maximum possible MCS, and MCS_Step is a correction factor for the current MCS and the average MCS_{current}, and MCS_Step is one of positive or negative depending on channel quality indicator (CQI) consistency.

10. The system of claim 9, wherein for b) MCS″=min {(average MCS(current)+MCS_step), MCSmax}, current weighted average MCS at a current time instant t, avgMCS_{current}, of a user equipment (UE) is computed as follows:
$${avgMCS}_{current} = {avgMCS}_{previous} * ( 1 - alpha ) + current MCS * alpha ,$$
wherein alpha is between 0 and 1, and avgMCSₚᵣₑᵥᵢₒᵤₛ is a weighted average of MCS at previous time instant t-1.

11. The system of claim 9, wherein:
$$prb ’ ’ = max ( \frac{{PRB}_{max}}{{\#UE}_{s}} , {PRB}_{avg} , 1 ) ,$$
PRB_avg is the average number of physical resource blocks (PRBs) allocated to UE counting all downlink (DL) slots, #UEs is the number of active UEs in the cell, and PRBₘₐₓ is the maximum number of possible PRBs in the cell.

12. The system of claim 9, wherein:
$$prb ’ ’ = max ( \frac{{PRB}_{max}}{{\#UE}_{s}} , {PRB}_{avg} , 1 ) ,$$
PRB_avg is the average number of physical resource blocks (PRBs) allocated to UE counting all downlink (DL) slots, #UEs is the number of active UEs in the cell, and PRBₘₐₓ is the maximum number of possible PRBs in the cell.

13. The system of claim 9, wherein:
the DU is configured to reduce the computed DDR for a DRB by a reduction value δ which depends on an amount of loss of downlink (DL) new radio user-plane sequence numbers (NR-UP SNs) in a specified time interval over a midhaul connection between the CU and the DU.

14. The system of claim 13, wherein:
the DU is configured to send to the CU-UP a flag along with the DDDS to indicate the computed DDR has been reduced to reflect the loss of DL NR-UP SNs.

15. The system of claim 9, wherein:
the CU-UP is configured to reduce the received DDR for a DRB by a reduction value ε which depends on an amount of loss of downlink (DL) new radio user-plane sequence numbers (NR-UP SNs) in a specified time interval over a midhaul connection between the CU and the DU.

16. The system of claim 9, wherein:
the CU-UP is configured to compute an effective DDR for a DRB based on the received DDR and information derived from the DDDS regarding a proportion of lost DL NR-UP SNs relative to transmitted NR-UP SNs in a specified time interval over a midhaul connection between the CU and the DU, wherein the effective DDR is the minimum value between i) the received DDR and ii) the proportion of lost DL NR-UP SNs relative to transmitted NR-UP SNs in the specified time interval.
